(19) United States
(12) Patent Application Publication
(10) Pub. No.: US 2015/0089866 A1
(43) Pub. Date: Apr. 2, 2015

(54) INTELLIGENT LIGHT SOURCES TO ENHANCE PLANT RESPONSE

(71) Applicant: Intelligent Light Source, LLC, San Diego, CA (US)

(72) Inventors: Jack Abbott, San Diego, CA (US); Peter A. Zeidler, Vista, CA (US); Alex Bodell, New York, NY (US)

(21) Appl. No.: 14/505,314

(22) Filed: Oct. 2, 2014

Related U.S. Application Data
(60) Provisional application No. 61/886,027, filed on Oct. 2, 2013.

(51) Int. Cl. A01G 7/04; A01G 25/16; F24F 11/00; H05B 37/02

(52) U.S. Cl. CPC A01G 7/045; H05B 37/0209; A01G 25/16; F24F 11/0009
USPC 47/58.1 LS; 315/307; 700/284; 700/276

(57) ABSTRACT

A grow system is disclosed herein. The grow system can include a grow device that can include a light system including a plurality of light sources, a light position controller, and a processor. The processor can receive information relating to a plant to be grown by the grow system and can, based on that information, identify an operation program that specifies lighting and positioning of the illumination system. Using the operation program, the processor can generate one or several control signals to control the operation of the light system and the light position system.

### CROSS-REFERENCES TO RELATED APPLICATIONS

This application claims the benefit of U.S. Provisional Application No. 61/886,027 entitled “INTELLIGENT LIGHT SOURCES TO ENHANCE PLANT RESPONSE,” and filed on Oct. 2, 2013, the entirety of which is hereby incorporated by reference herein.

### BACKGROUND

Greenhouse and other plant growth lighting systems are commonly used to promote plant growth in otherwise dark environments, or to supplement existing ambient light conditions.

Typically these lighting systems have been HPS or other broad spectrum lighting that have been optimized for human response and are often specified in lumens or other photometric units. Photometric units are based on human response, and therefore are they are not a good indicator of how a plant will respond. To partially address this issue, a unit called Photosynthetically Active Radiation (PAR) is often measured, although PAR does not fully characterize plant response, and varies with plant species and stage of growth.

### BRIEF SUMMARY

One aspect of the present disclosure relates to an active growth controller system. The system can include, for example, a climate control system that can affect at least one of a temperature and a relative humidity, and in some embodiments, the active growth controller system can include an irrigation system. In some embodiments, the active growth controller system can include an active growth control device including, an illumination system that can illuminate a growth region that can include one or several plants, a memory containing stored instructions, which stored instructions can include a plurality of operating programs, which operating programs can contain parameters for controlling at least one of the climate control system and the illumination system. In some embodiments, the active growth control device can include a processor that can receive first plant data, which first plant data identifies at least one of: a plant type, a plant age, a plant size, and a desired harvest outcome at a first time. The processor can retrieve the operating programs, identify an operating program corresponding to the first plant data, generate and send first control signals to the illumination system to control illumination of the growth region, which first control signals are generated based on the operating program and the first plant data, receive second plant data, which second plant data identifies at least one of a plant age, a plant size, and progress towards a desired harvest outcome at a second time, and generate and send second control signals to the illumination system to control illumination of the growth region, which second control signals are generated based on the operating program and the second plant data.

In some embodiments, the active growth control device is located within an enclosed agricultural hall. In some embodiments, the climate control system can control at least one of the temperature and the relative humidity within the enclosed agricultural hall.

In some embodiments, the processor can receive first climate data from the climate control system and generate and send third control signals to the climate control system, which third control signals can be generated based on the first plant data and the operating program, and which third control signals direct operation of the climate control system to achieve at least one of a first desired temperature and a first desired relative humidity within the enclosed agricultural hall. In some embodiments, the processor can receive second climate data from the climate control system and generate and send fourth control signals to the climate control system, which fourth control signals can be generated based on the second plant data and the operating program, and which fourth control signals direct operation of the climate control system to achieve at least one of a second desired temperature and a second desired relative humidity within the enclosed agricultural hall.

In some embodiments, the at least one of the first desired temperature and the first desired relative humidity are different than the second desired temperature and the second desired relative humidity and, in some embodiments, the first plant data is different than the second plant data. In some embodiments, the first control signals specify at least one of a first illumination intensity and a first frequency composition of light generated by the illumination system. In some embodiments, the second control signals specify at least one of a second illumination intensity and a second frequency composition of light generated by the illumination system, and the at least one of the first illumination intensity and the first frequency composition can be matched to at least one of the plant age and the plant size at the first time and the at least one of the first illumination intensity and the first frequency composition can be matched to at least one of the plant age and the plant size at the second time.

In some embodiments, the processor can adjust at least one of the first and second control signals to simulate at least one of the illumination intensity and the frequency composition of at least one of a sunrise and a sunset, and a season. In some embodiments, the processor can adjust the frequency composition by varying at least one of the red and blue frequency components of the light generated by the illumination system. In some embodiments, the frequency composition of the light generated by the illumination system is adjusted without diminishing the power output of the illumination system.

In some embodiments, the illumination system can include a red light source, a blue light source, and a broad-spectrum light source. In some embodiments, the frequency composition can be adjusted by decreasing the power provided to one of the red light source and the blue light source and by increasing the power provided to the other of the red light source and the blue light source. In some embodiments, the frequency composition is adjusted by increasing the power provided to the broad-spectrum light source.

One aspect of the present disclosure relates to a method of optimizing plant growth. The method includes receiving first plant data, which first plant data identifies at least one of: a plant type, a plant age, a plant size, and a desired harvest outcome at a first time, receiving grow parameter data, which grow parameter data specifies at least one of an available grow time, and a cost parameter, which cost parameter identifies a maximum cost for completion of the grow, identifying an operating program corresponding to the first plant data and the grow parameter data, which operating program can include a control parameter for controlling the operation of an active growth control system. In some embodiments, the active growth control system can include a memory, a processor, and an illumination system that can illuminate one or several plants in a growth region. In some embodiments, the method can include generating and outputting first control signals to the illumination system, which first control signals can control illumination of the growth region, and which first control signals are generated based on the operating program and the first plant data, receiving second plant data, which second plant data identifies at least one of a plant age, a plant size, and progress towards a desired harvest outcome at a second time, and generating and send second control signals to the illumination system to control illumination of the growth region, which second control signals are generated based on the operating program and the second plant data.

In some embodiments, the method includes receiving first climate data from the climate control system and generating and sending third control signals to the climate control system, which third control signals are generated based on the first plant data and the operating program, and which third control signals direct operation of the climate control system to achieve at least one of a first desired temperature and a first desired relative humidity within the enclosed agricultural hall. In some embodiments, the method includes receiving second climate data from the climate control system and generating and sending fourth control signals to the climate control system, which fourth control signals are generated based on the second plant data and the operating program, and which fourth control signals direct operation of the climate control system to achieve at least one of a second desired temperature and a second desired relative humidity within the enclosed agricultural hall.

In some embodiments, the first control signals specify at least one of a first illumination intensity and a first frequency composition of light generated by the illumination system, the second control signals specify at least one of a second illumination intensity and a second frequency composition of light generated by the illumination system, and the at least one of the first illumination intensity and the first frequency composition is matched to at least one of the plant age and the plant size at the first time and the at least one of the second illumination intensity and the second frequency composition is matched to at least one of the plant age and the plant size at the second time. In some embodiments, the method includes adjusting the frequency composition of light generated by the illumination system by: determining a first power output level of the illumination system at a first instance, generating a first signal to direct the decrease of illumination generated by one of a red light source and a blue light source, and generating a second signal to direct the increase of illumination generated by the other of the red light source and the blue light source such that the power output level of the illumination system after the first and second signals is the same as at the first instance.

In some embodiments, the method includes determining the completion of the operating program, determining a parameter of the result of the operating program, which parameter characterizes a yield from the operating program, comparing the parameter of the result of the operating program to parameters of results received from other programs, and identifying the relative effectiveness of the completed operating program. In some embodiments, the parameter of the result of the operating program can include one of: a descriptor of harvest size, a descriptor of a consumer satisfaction level, a descriptor of a chemical composition, a descriptor of a presence of a pharmacological property, and a descriptor of a visual attribute.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a perspective view of one embodiment of an active growth device.

FIG. 2 is a schematic illustration of one embodiment of an active growth control system.

FIG. 3 is a schematic illustration of one embodiment of the memory of the active growth control system.

FIG. 4 is a flowchart illustrating one embodiment of a process for operation of an active growth control system.

FIG. 5 is a flowchart illustrating one embodiment of a process for selecting an operating program for control of the active growth control system.

FIG. 6 is a flowchart illustrating one embodiment of a process for optimizing the operating program for control of the active growth control system.

FIG. 7 is a flowchart illustrating one embodiment of a process for implementing an operation program.

FIG. 8 is a flowchart illustrating one embodiment of a process for matching lighting to lighting parameters specified in the operation program.

FIG. 9 is a flowchart illustrating one embodiment of a process for generating a pulse pattern.

FIG. 10 is a flowchart illustrating one embodiment of a process for evaluating the result of an operation program.

FIG. 11 is a block diagram of an embodiment of a computer system.

FIG. 12 a block diagram of an embodiment of a special-purpose computer system.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In one embodiment, the present disclosure relates to devices, systems, and methods for controlling, improving, and/or optimizing the growth of one or several plants. In some embodiments, these systems, devices, and methods can include features or functions that can allow the creation, selection, and/or optimization of a program that can control one or several parameters that are important to the growth of a plant. These parameters can relate to, for example, lighting, irrigation, nutrients, temperature, humidity, or the like. The use of this program allows the customization of the environment in which the plant grows to, for example, affect the time required to grow the plant, affect the harvest from the plant, including, for example, the size and/or weight of the harvest and/or one or several attributes of the harvest, affect one or several nutritional and/or pharmacological properties of the plant, and/or affect the cost of growing the plant. Generally, the devices, systems, and methods customize aspects of the environment to increase plant growth efficiency and to achieve one or several desired outcomes.

In some embodiments, the lighting provided to the plant can be controlled to increase growth efficiency and/or to achieve one or several desired outcomes. Specifically, the spectral and/or frequency composition, referred to herein as the frequency composition, the intensity, and the timing of the lighting can be controlled to increase growth efficiency and/or to achieve one or several desired outcomes.

To achieve this control of the lighting, the program can include information affecting the frequency composition and/or the intensity of light that illuminates the plant. The information affecting the frequency composition and/or the intensity of light that illuminates the plant can be matched to a plant property such as the plant type including, the plant genus, species, cultivar, strain, or the like, the plant age and/or growth phase, or the like to increase the efficiency with which the plant can use the light. Similarly, in some embodiments, the program can include information affecting the frequency composition and/or the intensity of light that illuminates the plant to mimic one or several natural cycles such as a day-cycle, a seasonal-cycle, or the like. In such an embodiment, the program may include information to replicate lighting of one or several sunrises, sunsets, seasons, and/or global positions.

In some embodiments, the lighting can be controlled to maximize the lighting received by all portions of the plant's canopy. In one such embodiment, the position and the intensity of the lighting can be controlled such that a desired level of lighting is received by leaves in inner portions of the canopy of the plant. In some such embodiments, the program can include information relating to control of the lighting to allow achievement of desired lighting levels of the leaves in inner portions of the canopy with damaging any of the leaves of the canopy.

Additionally, the devices, systems, and methods disclosed herein can gather and share information to allow optimization of one or several of the programs controlling the systems and devices to affect plant growth. This can be achieved by the maintaining of data relating to one or several parameters relating to the environment in which the plant grew, and collection of data relating to one or several parameters of the harvest and/or result of the growth program. This collection and/or sharing can be performed according to any desired model including, for example, a crowd-source model. In such an embodiment, this information can be gathered and aggregated with information collected by other device and/or systems, or collected from the same device and/or system at a different time to determine the effectiveness of one or several programs in achieving a desired result. With the effectiveness of the programs determined, one or several of the programs can be updated to improve results achieved with those one or several programs.

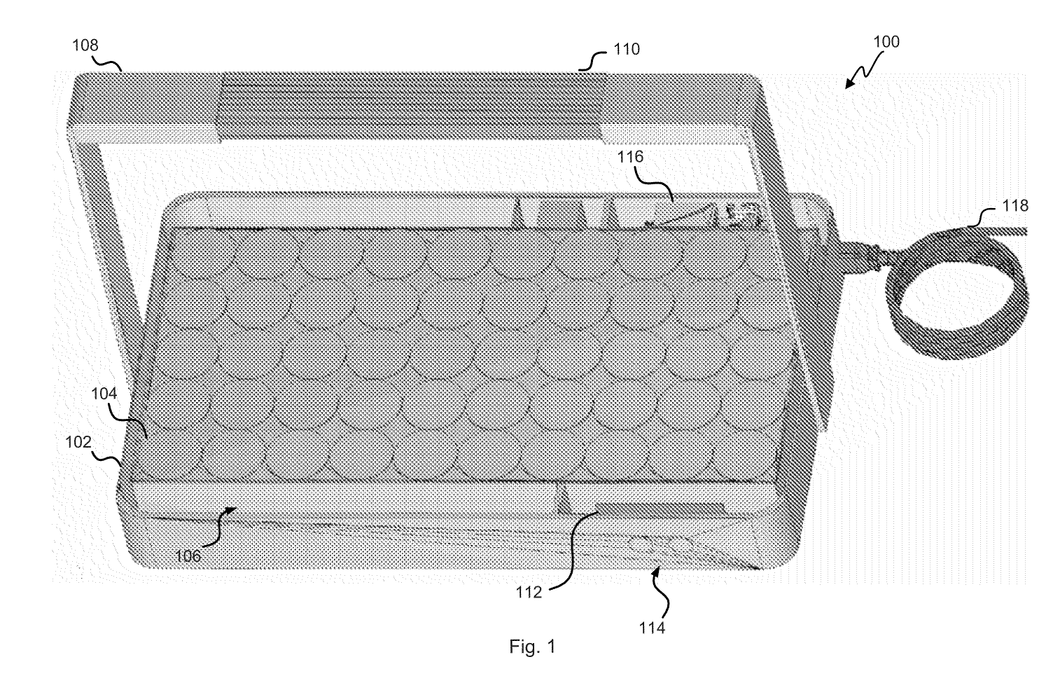

With reference now to FIG. 1, a perspective view of one embodiment of an active growth device 100, also referred to herein as a grow device, is shown. The grow device 100 can comprise a variety of shapes and sizes and can be made from a variety of materials. In some embodiments, the grow device 100 can be sized and shaped for non-professional use, such as, for example, by hobby/home horticulturist, and in some embodiments, the grow device 100 can be sized and shaped for professional use.

The grow device can include a body 102 that can contain, for example, one or several growth regions 104. The growth region 104 can be a place in which one or several plants can be grown. The growth region 104 can include growth media, also referred to herein as soil, such as, for example, any media that can support a root system of the plant and that, in aggregate, is sufficiently porous to allow circulation of water and nutrients through itself. The growth media can be, for example, an organic growth media such as moss or manure, an inorganic growth media such as, for example, sand, rock, clay, Styrofoam, and/or a hybrid media such as soil.

The grow device 100 can include a reservoir 106 that can be, for example, a water reservoir. The reservoir 100 can be configured to hold water that is circulated through the growth media. The reservoir 100 can have a variety of shapes and sizes, but in some embodiments, can be sized to hold sufficient water to allow operation of the grow device 100 for, for example, 1 day, 2 days, 3 days, 4 days, 5 days, 6 days, 1 week, 1 month, 2 months, and/or any other or intermediate period of time without refilling of the reservoir 106. Further, in some embodiments, the reservoir 106 can include features that enable the reservoir 106 to auto-refill when the water level in the reservoir 106 drops below a minimum level.

The grow device 100 can include a lighting system 108. The lighting system 108 can include one or several light sources 110 that can illuminate the one or several growth regions 104, and particularly can illuminate one or several plants growing in the growth regions 104. In some embodiments, the lighting system 108 can be configured to allow the variable, controllable positioning of the one or several light sources 110 with respect to the growth regions 104. This can include, for example, changing of the angular position of the one or several light sources 110 with respect to the one or several growth regions 104 and/or changing the distance between the one or several light sources 110 and the one or several growth regions 104.

As mentioned, the light system 108 can include the one or several light sources 110 that can be controllable to illuminate the growth regions 104. The one or several light sources 110 can include any light emitting feature/device including, for example, one or several light bulbs, light emitting diodes (LEDs), or the like. In some embodiments, the one or several light sources 110 can be configured to generate one or several frequencies of light and/or one or several ranges of frequencies of light, which configuration will be discussed at greater length below.

The grow device 100 can include a controller 112 also referred to herein as a processor. The processor 112 can control the operation of the components of the grow device 100, and in some embodiments, can control the operation of components of the grow system. The processor 112 can be a microprocessor, such as a microprocessor from Intel® or Advanced Micro Devices, Inc.®, or the like. In some embodiments, the processor 112 can act according to one or several stored instructions that can be stored in memory associated with the processor 112 and/or communicatingly connected with the processor 112.

The grow device 110 can include a user interface 114 that communicates information to, and receives inputs from the user. In some embodiments, the user interface 114 can include one or several sensors configured to sense a physical result of one or several user actions, and to convert this sensed result into an electric signal. In some embodiments, the one or several sensors can be configured to sense pressure and/or pressures such as, for example, one or several pressures exceeding a threshold value, and can include, for example, a keyboard, a touchscreen, a mouse, or the like. In some embodiments, the one or several sensors can be configured to sense sound and/or pressure waves, and can include, for example, one or several microphones. The user interface 114 can also include one or several features configured to output information to a user in a human-consumable format, and particularly to transform one or several electrical signals into a human-consumable format. These one or several features can include, for example, a screen, a speaker, a monitor, or the like. In the embodiment depicted in FIG. 1, the user interface 114 includes a plurality of buttons.

The grow device 100 can include a power supply 116 and a cable 118. In some embodiments, the cable 118 can be configured to provide power, such as electric power, to the grow device 100, and the power supply 116 can be configured, for example, to regulate and/or transform the power received via the cable 118.

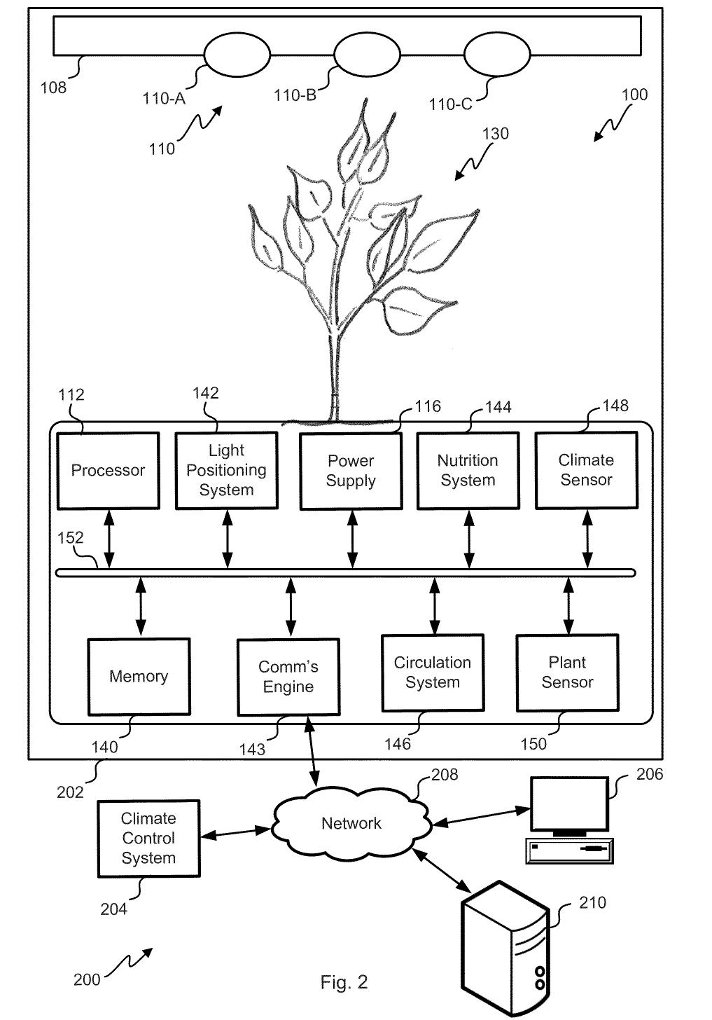

With reference now to FIG. 2, a schematic illustration of one embodiment of an active growth control system 200, also referred to herein as a grow system, is shown. The grow system 200 can include the grow device 100 that can include, for example, the body 102, the processor 112, and the light system 108 and the light sources 110. As seen in FIG. 2, the light sources 110 can include a plurality of different light sources 110-A, 110-B, 110-C that can be, for example, light sources 110 that generate light with a different frequency and/or range of frequencies. Specifically, in some embodiments, the light sources 110 can include a blue light source 110-A that generates visible light in the blue frequencies, a red light sources 110-B that generates visible light in the red frequencies, and a broad-spectrum light source 110-C that generates visible light across the visible spectrum. In some embodiments, the light sources 110-A, 110-B, 110-C are individually controllable, and in some embodiments, the light sources 110-A, 110-B, 110-C are simultaneously controllable.

As further, seen, the grow device 100 includes memory 140. Memory 140 can be, for example, flash memories, read-only-memories (ROMs), battery-backed volatile memories, networked storage devices, and the like. In some embodiments, the memory can be local and/or remote, including, for example, cloud storage. In some embodiments, memory 140 can include one or several databases that will be discussed at greater length below.

The grow device 100 includes a light positioning system 142. The light positioning system 142 can include one or several motors and/or actuators that can change the position of the light sources 110 with respect to the growth regions 104, and particularly can change the distance between the light sources 110 and the growth regions 104 of the grow device 100. In some embodiments, the light positioning system 142 can be controlled by one or several signals received from the processor 112.

The grow device 100 can include a communication engine 143. The communication engine 143 can be configured to communicate with components of the grow system 200 that are not included in the grow device 100. The communication engine 143, can be configured to send and/or receive signals including coded instructions, and can send and/or receive these signals via a wired or wireless connection with the other components of the grow system 200.

The grow device can include a nutrition system 144. The nutrition system 144 can be configured determine the nutrition levels of the plant 130 and to adjust those nutrition levels. The nutrition system 144 can determine nutrition levels of the plant by sensing levels of one or several nutrients in the plant 130 itself, such as, for example, by performing a spectral scan of all or a portion of the plant 130 such as, for example, of a leaf, a stem, a root, a bud, a flower, a blossom, or the like, by sensing levels of one or several nutrients in the reservoir 106, and/or by sensing levels of one or several nutrients in the growth media. In some embodiments, the nutrition system 144 can be configured to provide signals identifying the sensed nutrition levels to the processor 112, and then, can be configured to receive one or several signals directing the operation of the nutrition system 144 to increase the nutrition levels by, for example, adding a fertilizer to the reservoir 106 and/or to the growth media, or the like.

The grow device 100 can include an irrigation system 146. The irrigation system 146 can irrigate the plant 130 and/or circulate water from the reservoir 106 through the growth media. The irrigation system 146 can include one or several valves, sensors, and/or pumps. In some embodiments, the irrigation system 146 can sense the rate of circulation, a moisture level of the growth media, and/or a hydration level of the plant. This sensed information can be provided to the processor 112 which can provide one or several signals to the irrigation system 146, which signals direct the operation of the pump and the valves to control the circulation of water through the growth media.

The grow device 100 can include a climate sensor 148. The climate sensor 148 can sense an aspect of the climate in the environment in which the plant 130 is growing. The climate sensor 148 can sense, for example, a temperature, an air velocity, a humidity including, for example, a relative humidity, an atmospheric pressure, an atmospheric composition, or the like.

The grow device 100 can include a plant sensor 150. The plant sensor 150 can be configured to sense one or several attributes of the plant 130 such as, for example, the size of the plant 130, including, for example, the height and/or weight, the age of the plant, any harvest associated with the plant, a property of the plant such as, for example, the presence, concentration, and/or composition of one or several chemicals, including pharmacological chemicals contained in the plant, or the like. In some embodiments, the plant sensor 150 can comprise one or several cameras, scales, scanners, or the like.

In some embodiments, the above discussed components of the grow device 100 can be communicatingly connected. In some embodiments, this communicating connection can be wired or wireless, and can be, for example, via a bus 152.

In some embodiments, the grow device 100 can be located within enclosed area 202. The enclosed area can be any size larger than the grow device 100 and can include, for example, a room, a building, a warehouse, an enclosed agricultural hall such as an indoor a professional or hobbyist agricultural area, or the like. In some particular embodiments, one or several attributes of the enclosed area 202 may be controllable, and particularly, in some embodiments, one or several climate-attributes of the enclosed area 202 may be controllable, including, for example, the temperature, the air velocity, the humidity including, for example, the relative humidity, the atmospheric pressure, the atmospheric composition, or the like. In some embodiments, these attributes can be sensed by the climate sensor 148, and can be affected and/or controlled by the climate control system 204, which can include, for example, an HVAC system, a humidifier, a vacuum pump, or the like.

The grow system 200 can further include one or several user devices 206. The one or several user devices 206 can be any computing device capable sending and receiving information including, for example, a computer including, for example, a personal computer, a laptop, a handheld device including, for example, a cell phone, a smart phone, a PDA, or the like. In some embodiments, the user device 206 can include one or several sensors configured to sense a physical result of one or several user actions, and to convert this sensed result into an electric signal. In some embodiments, the one or several sensors can be configured to sense pressure and/or pressures exceeding a threshold value, and can include, for example, a keyboard, a touchscreen, a mouse, or the like. In some embodiments, the one or several sensors can be configured to sense sound and/or pressure waves, and can include, for example, one or several microphones.

The grow system 200 can include a network 208. The network 208 allows communication between the components of the grow system 200. The network 208 can be, for example, a local area network (LAN), a wide area network (WAN), a wired network, wireless network, a telephone network such as, for example, a cellphone network, the Internet, the World Wide Web, or any other desired network. In some embodiments, the network 208 can use any desired communication and/or network protocols.

The grow system 200 can include one or several database servers 210. The one or several database servers 210 can comprise one or several storage media that can be arranged in any desired fashion. In one embodiment, for example, the database servers 210 can comprise one or several memory blade server, hard drive server, or the like.

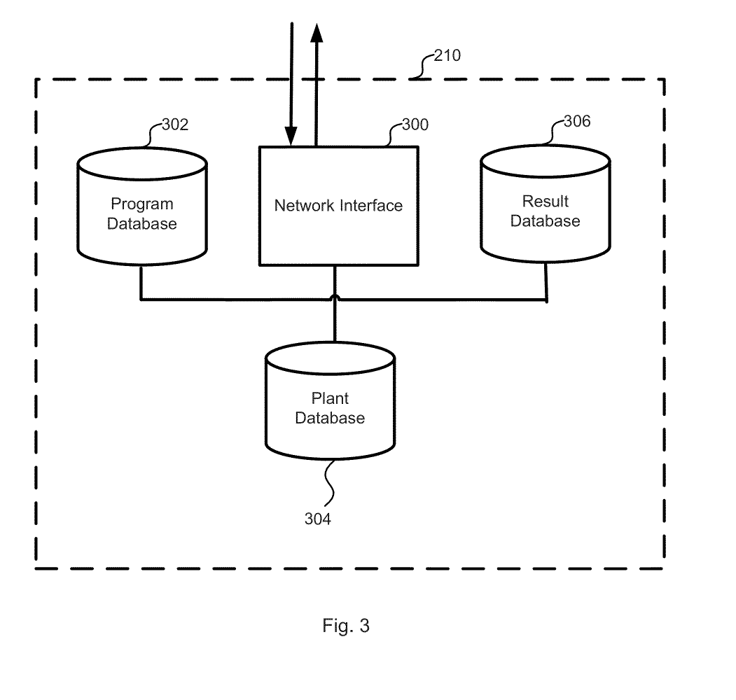

With reference now to FIG. 3, a schematic illustration of one embodiment of an exemplary one of the one or several database servers 210. As depicted, the database server 210 can include a network interface 300 that can allow the database server 210 to communicate with other components of the grow system 200. In some embodiments, the network interface 300 can be configured to access the network 208. The network interface 300 can include features configured to send and receive information, including, for example, an antenna, a modem, a transmitter, receiver, or any other feature that can send and receive information. The network interface 300 can communicate via telephone, cable, fiber-optic, or any other wired communication network. In some embodiments, the network interface 300 can communicate via cellular networks, WLAN networks, or any other wireless network.

The database server 210 can include a plurality of databases including, for example, a program database 302. The program database can include a plurality of operating programs, also referred to herein as operation programs, that can control the operation of the grow system 200.

In some embodiments, the program database 302 can further include information linking the operating programs to one or more plant types.

In some embodiments, these links between operating programs and plants can be based on outcomes achieved through the use of the operating programs for the types of plants to which the operating programs are linked. Thus, a first operating program may be linked with a type of plant such as a species, a genus, a cultivar, and/or a strain due to degree of success had in achieving a desired outcome when using the first operating program for that type of plant.

In some embodiments, the operating programs can be designed based on data gathered from a natural environment in which the type of plant is grown. Particularly, in some embodiments, the operating program can be based on data gathered from natural environments in which the type of plant flourishes and/or achieves a desired result. This can include data relating to hours of light in a day, frequencies of light at the location, temperatures, humidities, atmospheric pressures, soil composition, soil moisture levels, nutrient levels, and/or the like.

In some embodiments, the programs can be generated and/or optimized based on results achieved by other users of the grow system and/or from other plants raised with the grow system. In some embodiments, the grow system 200 can gather and store data relating to previous and/or other plants raised with the grow system 200 and can use this data to identify the results of one or several grow programs. This can also allow identification of one or several aspects of the operating program that either positively or negatively impact one aspect of one or several plants raised with the grow system 200. With this information, and with the data gathered by the grow system 200, operating programs can be optimized for desired results.

The database server 210 can include a plant database 304. In some embodiments, the plant database can include information relating to one or several plants. This can include information relating to the growth cycle of the plant, plant size, plant yield, plant disease susceptibility, and/or the like. In some embodiments, the plant database 304 can include information linking one or several plants and/or plant types to one or several of the operating programs.

The database server 210 can include a result database 306. The result database 306 can include information relating to the results of one or several operating programs, and can specifically include information linking the results of one or several operating programs with one or several plants and/or plant types. In some embodiments, this information can relate to plant size, weight, height, color, flavor, culinary desirability, pharmacological desirability, chemical composition, pharmacological properties, active substances, or the like. In some embodiments, this information can be gathered during the running of the operating program, and in some embodiments, this information can be gathered at the completion of the operating program. Additionally, in some embodiments, the result database can include information relating to the cost of the completion of the operating program, the amount of energy used in the completion of the operating program, environmental conditions, both in, and outside of the enclosed area 202 during the running of the operating program, or the like.

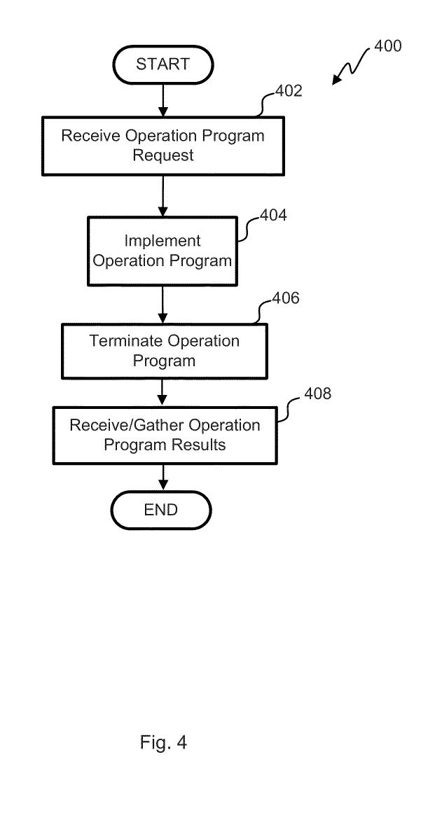

With reference now to FIG. 4, a flowchart illustrating one embodiment of a process 400 for operation of an active growth control system 200 is shown. The process begins at block 402, wherein an request for an operation program is received. In some embodiments, the request for an operation program can comprise receipt of an electric signal indicating a user selected operating program and/or other receipt of an electric signal indicating the confirmation of a processor 112 selected operating program. The request can be received by a component of the grow system 200 such as, for example, the user device 206.

After the operation program request has been received, the process 400 proceeds to block 404, wherein the operation program is implemented. In some embodiments, the operation program can be implemented by the processor generating and sending one or several control signals to one or several components of the grow system 200. In some embodiments, these one or several control signals can direct an action by the recipient components of the grow system, which action can correspond to a component of the operating program. In some embodiments, the implementation of the grow program can comprise looping through a process of measuring one or several parameters relating to the plant 130 and/or to the environment in which the plant is growing, comparing these parameters to the operating program, and generating one or several control signals to remedy identified differences between these parameters and the operating program.

After the operating program has been implemented, the process 400 proceeds to block 406, wherein the operation program is terminated. In some embodiments, the operation program can be terminated when a predetermined amount of time has passed, when a predetermined amount of money has been spent, when a predetermined plant size and/or anticipated harvest has been reached, when a predetermined attribute, such as a predetermined pharmacological attribute has been attained, or the like.

After the operating program has been terminated, the process 400 proceeds to block 408, wherein the grow system 200 gathers and aggregates the results of the operation program. In some embodiments, these results can be gathered by one or several sensors connected to and/or associated with the grow system 200, and in some embodiments, these results can be gathered via, for example, a questionnaire, a survey, or the like. In some embodiments, the gathering, receiving, and/or aggregation of these results can include the comparative analysis of one or several of the operation programs, and the optimizing of one or several of these operation programs. The data characterizing the results of the operation program can be stored in the database server 210, and particularly can be stored in the results database 306 of the database server 210.

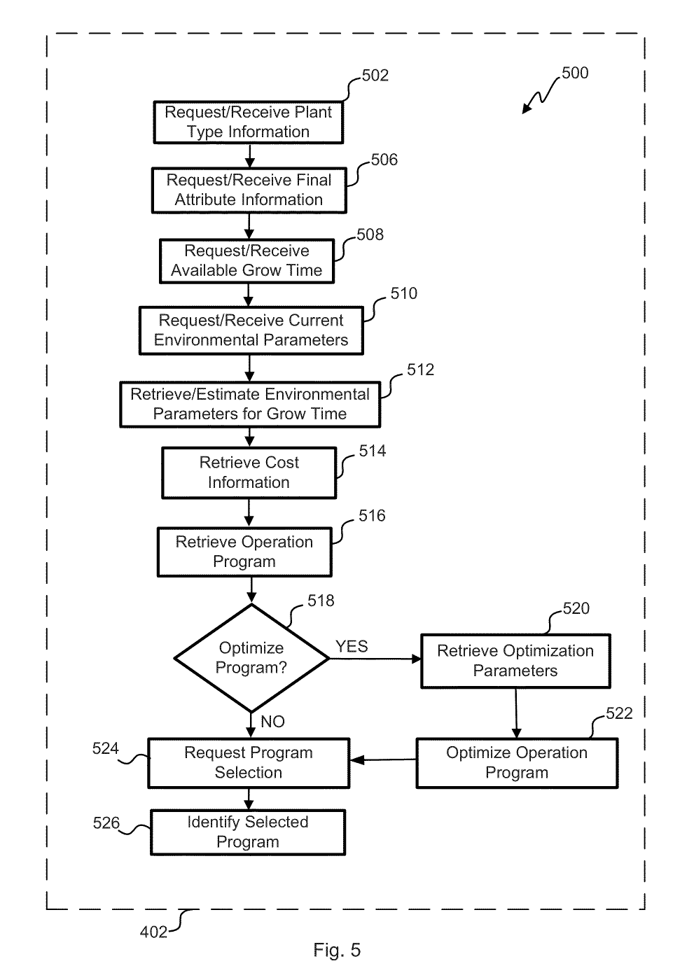

With reference now to FIG. 5, a flowchart illustrating one embodiment of a process 500 for selecting an operating program for control of the active growth control system 200 is shown. The process 500 can be performed in the place of block 402 shown in FIG. 4, or a part of block 402 shown in FIG. 4, and can be performed by the grow system 200 and/or by components thereof.

The process 500 begins at block 502, wherein plant type information is requested and received. In some embodiments, this can include the receipt of a signal by the grow system 200, and specifically by the user device 206 and/or the processor 112 of the grow system 200, indicating a desire to initiate an operation program. In response to this request, the grow system 200 can request information relating to the plant type. In some embodiments, this information can be requested via a prompt to identify the plant type via, for example, providing information relating to the plant genus, species, cultivar, strain, and/or the like. In some embodiments, this information can be provided via one or several drop-down menus, and in some embodiments, this information can be stored in the database server 210 such as, for example, the plant database 304.

After the grow system 200 has requested information relating to the plant type, step 502 can further include the receipt of plant type information from the user via, for example, the user device 206. Alternately, in some embodiments, the grow system 200 can include information to allow the genetic testing of plant material to determine plant type information. In such an embodiment, this testing can be performed by the plant sensor 150.

After the plant type information has been requested and received, the process 500 proceeds to block 506, wherein final attribute information is requested and received. The final attribute information can identify one or several desired outcomes of the growth of the plant with the operating program. These outcomes can include, for example, information identifying a desired plant size, a desired plant weight, a desired harvest including, for example, a desired number of harvested items such as a number of flowers or of fruits, vegetables, or harvestable plant parts, a desired volume and/or weight of harvestable items, a desired attribute such as, for example, a desire flower color, size, and/or smell, a desired harvestable item color, size, smell, flavor, texture, composition, pharmacological property, or the like. In some embodiments, the final attribute information can be requested by the processor 112 and/or by the user device 206 and can be received by the user device 206, and/or by the processor 112. This final attribute information can be stored in the database server 210, and particularly in the result database 306 of the database server 210.

After the final attribute information has been requested and received, the process 500 proceeds to block 508, wherein information identifying the available grow time is requested and/or received. In some embodiments, for example, this information can identify when the plants will be harvested, a date by which the plants need to be delivered to market and/or to a buyer, a duration of a period of time available for running the operating program, or the like. In some embodiments, this information can be requested by the processor 112 and/or by the user device 206 and can be received by the user device 206, and/or by the processor 112.

After the available grow time information has been requested and/or received, the process 500 proceeds to block 510, wherein one or several environmental parameters, including, for example, current environmental parameters, are requested and/or received. In some embodiments, this information can correspond to the identification of the current state of the environment in which the plant will be grown such as, for example, the environment inside of the enclosed area 202, and in some embodiments, this can include information relating to the environment outside of the enclosed area 202.

These environmental parameters can include, for example, a soil composition, a soil moisture level, an air temperature level, a soil temperature level, a humidity level, a soil pH level, soil nutrient levels, water level, water nutrient levels, water temperature levels, or the like. In some embodiments, this information can be received from the user via the user device 206 in response to a request for information, in some embodiments, this information can be retrieved by one or several sensors of the grow system 100, and in some embodiments, this information can be retrieved by the grow system 100 from one or several weather information providers.

After the environmental parameters have been requested and received, the process 500 proceeds to block 512, wherein environmental parameters for the grow time are estimated. In some embodiments, this estimate can focus on an estimation of environmental parameters outside of the enclosed area 202 such as, for example, and outside temperature, sunrise/sunset times, outside humidity, outside soil temperatures, and/or the like. In some embodiments, these estimates can be based on average weather information for the dates during which the operating program will run. This information can be used to determine the amount of energy that will be entering and/or exiting the enclosed area 202 during the running of the operation program.

After the environmental parameters are estimated for the grow time, the process 500 proceeds to block 514, wherein cost information is received. In some embodiments, the cost information can identify one or several of energy cost during the grow time, total acceptable cost for raising of the plants, desired profitability for the raised plants and/or desired harvest, or the like. In some embodiments, this step can include the aggregation of information from one or several data sources such as, for example, one or several power providers, one or several markets, or the like. This information can be stored in database server 210, and particularly in the result database 306 of the database server.

After the cost information has been retrieved, the process 500 proceeds to block 516, wherein one or several operation programs are retrieved. In some embodiments, the operation programs can be retrieved by a comparison of some or all of the information received in blocks 502 to 514 with one or several components of the operation programs. In some embodiments, this can include, matching the plant type and the desired outcome to the operation programs most likely to achieve that desired outcome for the plant type.

After the one or several operation programs have been retrieved, the closest matching operating program is selected. This operating program can be the operation program that is most likely to achieve the desired outcome for the identified plant given the available grow time, the environmental parameters, and the estimated environmental parameters. After the operation program has been retrieved, the process 500 proceeds to decision state 518, wherein it is determined whether to optimize the program. In some embodiments, this determination can include comparing the closeness of the match between the operation program and the information from blocks 502 to 514 to a threshold value and/or comparing the likelihood of achieving the desired outcome to a threshold value. In some embodiments, this can include, for example, comparing whether the desired outcome is likely to be achieved within the cost parameters specified in the cost information.

If it is determined to optimize the program, then the process 500 proceeds to block 520, wherein one or several optimization parameters are retrieved. In some embodiments, the one or several optimization parameters can be one or several aspects of the operation program, a change to which is most likely to result in the achievement of the desired outcome and/or in an improvement of the operation program. In some embodiments, the cost parameters can comprise one or several functions identifying expected results achieved through the change of one or several variables in the operation program. In some embodiments, these one or several optimization parameters can be identified based on data gathered from previous uses of the grow system 200.

After the optimization parameters are retrieved, the process 500 proceeds to block 522, wherein the operation program is optimized. In some embodiments, this can include determining of the changes to the operation program that will yield the most improved results with smallest detrimental effect on the operation program. Information relating to the optimization of the operation program, including details of how the operation program was optimized can be stored in the database server 210, and particularly in the program database 302 of the database server 210.

After the operation program has been optimized, or returning again to decision state 518, if it is determined to not optimize the program, the process 500 proceeds to block 524, wherein a program selection is requested. In some embodiments, this can include presenting one or several potential operation programs to the user via, for example, the user device 206. This presenting of one or several potential operation programs can include the identification of one or several positive and negative aspects of these one or several potential operation programs. After the program selection has been requested, the process 500 proceeds to block 526, wherein a selection of one or the programs is received, and the selected program is identified.

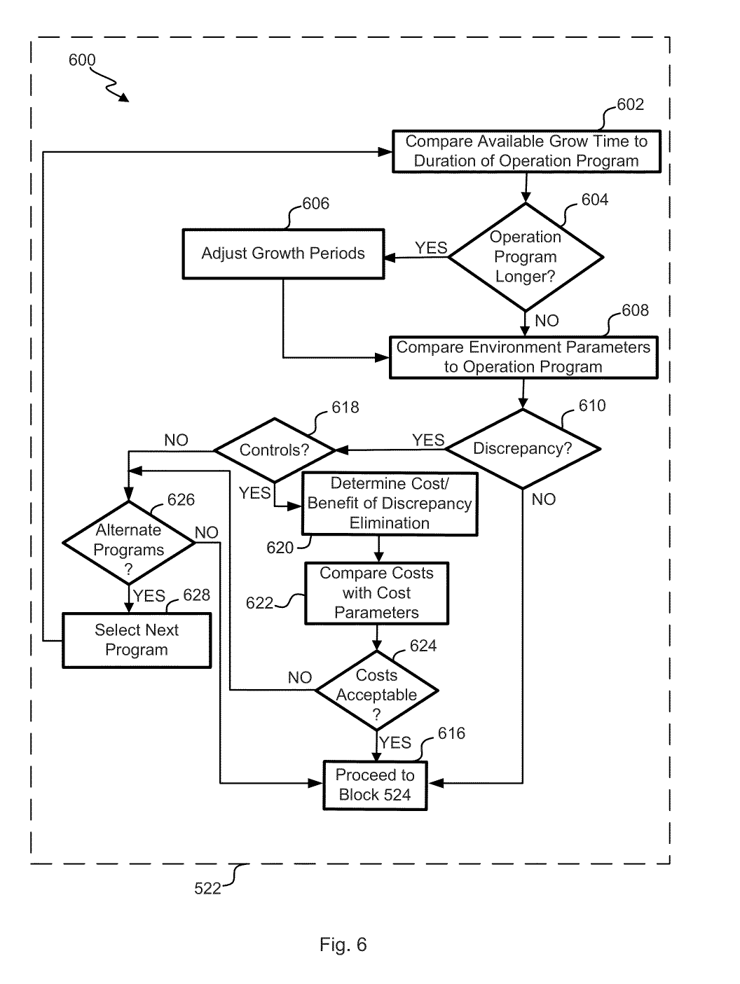

With reference now to FIG. 6, a flowchart illustrating one embodiment of a process 600 for optimizing the operating program for control of the active growth control system 200 is shown. The process 600 can be performed in the place of, or as a part of block 522 of FIG. 5.

The process 600 begins at block 602, wherein the available grow time is compared to the duration of the unmodified operation program. In some embodiments, a first, “true” Boolean value is associated with the operation program if its duration does not exceed the available grow time, and a second, “false” Boolean value is associated with the operation program if its duration exceeds the available grow time. After the available grow time is compared to the duration of the operation program, the process 600 proceeds to decision state 604, wherein it is determined if the duration of the operation program is longer than the available grow time. In some embodiments, this can include determining which of the first and second Boolean values are associated with the program.

If the second Boolean value is associated with the program, then the duration of the operation program is longer than the available grow time, and the process 600 proceeds to block 606, wherein the growth periods within the program are adjusted. In some embodiments, for example, the operation program can include a plurality of growth periods, which growth periods can correspond with one or several parts of a day, days, weeks, months, and/or seasons. In some embodiments, a plant can experience different aspects of growth during the “day,” a period of relatively more illumination, than during the “night,” a period of relatively lesser illumination. However, as the day and/or the night progressively increases in length, the benefit of the aspect of growth achieved during that time diminishes. Thus, the marginal benefit achieved by extending the length of a growth period diminishes as the length of the growth period increases. Accordingly, by decreasing the duration of one or both of the “day” and the “night,” the relative benefit of each hour spent in each period can be increased and the overall time required for the plant to reach maturity can decrease. Thus, in embodiments in which the duration of the operation program is longer than the available grow time, the duration of the growth periods can be decreased to increase the speed with which the plant reaches maturity.

After the growth periods are adjusted, or returning to decision state 604, if it is determined that the first Boolean value is associated with the program, and that the duration of the program is shorter than the available grow time, the process 600 proceeds to block 608, wherein the environmental parameters are compared to the operation program. These environmental parameters can include, for example, climate parameters inside of the enclosed area 202, climate parameters outside of the enclosed area 202, and/or any other parameter relevant to the growth of the plant. In some embodiments, if an environmental parameter matches the operation program, then a first, “true” Boolean value is associated with the environmental parameter, and if the environmental parameter does not match the operation program, then a second, “false” Boolean value is associated with the environmental parameter.

After the environmental parameters have been compared to the operation program, the process 600 proceeds to decision state 610, wherein it is determined if there is a discrepancy between the environmental parameters and the operation program. In some embodiments, this can include, for example, determining whether a first or a second Boolean value is associated with each of the environmental parameters. If a first Boolean value is associated with all of the environmental parameters, and the environmental parameters thus match the operation program, then the process 600 proceeds to block 616 and continues with block 524 of FIG. 5.

Returning again to decision state 610, if the second Boolean value is associated with some or all of the environmental parameters, then the process 600 proceeds to decision state 618, wherein it is determined if the grow system 200 includes control to affect the environmental parameters that do not match the operation program. Thus, it is determined if the grow system 200 is capable of affecting the discrepancy between the environmental parameters and the operation program.

If it is determined that the grow system 200 can affect the environmental parameter that deviates from the operating program, then the process 600 proceeds to block 620, wherein the cost/benefit tradeoff of the resolution of the discrepancy between the environmental parameters and the operation program is determined. In some embodiments, this can include, for example, determining the cost of decreasing or increasing the temperature, humidity, atmospheric pressure, soil composition, soil pH, or the like in the enclosed area 202 and/or in the growth regions to more closely match the operation program and the benefits of those changes. Once the costs and the benefits of the changes are determined, the process 600 proceeds to block 622, wherein the costs and the benefits are compared with the cost parameters and/or cost information. In some embodiments, this can include determining whether and/or to what degree the environmental parameters can be changed to match the operation program while staying within cost constraints for the running of the operation program. In some embodiments, a first, “true” Boolean value can be associated with a change to an environmental parameter if the change would likely not result in a violation of a cost constraint, and second, “false” Boolean value can be associated with a change to an environmental parameter if the change would likely result in a violation of a cost constraint.

After the costs and the cost parameters have been compared, the process 600 proceeds to decision state 624, wherein it is determined if the costs of the environmental change are acceptable. In some embodiments, this can include determining whether the first or the second Boolean value is associated with a prescribed change to one of the environmental parameters. If the cost is acceptable, then the operating program is updated to control for this deviation from the environmental parameter to the operation program and the process proceeds to block 616 and continues with block 524 of FIG. 5.

If it is determined that the costs are unacceptable, or returning again to decision state 618, if it is determined that the grow system 200 does not include controls to affect the environmental parameters that do not match the operation program, then the process 600 proceeds to decision state 626, wherein it is determined if there are alternate programs to achieve the desired outcome. In some embodiments, these alternate programs may be selected as being more adaptable and/or as being more easily or more cheaply adapted. Specifically, these alternate programs may more closely match the environmental parameters, both current and predicted, and thus may be more cost effectively optimized to match the current environmental parameters. If there is not an alternate program, then the process 600 proceeds to block 616, and continue to block 524 of FIG. 5.

If it is determined that there are alternate programs, then the process 600 proceeds to block 628, wherein the next operation program is selected. In some embodiments, the next operation program can be the operation program that has the next highest likelihood of achieving the desired outcomes. After the next operation program has been selected, the process 600 returns to block 602 and proceeds as outlined above.

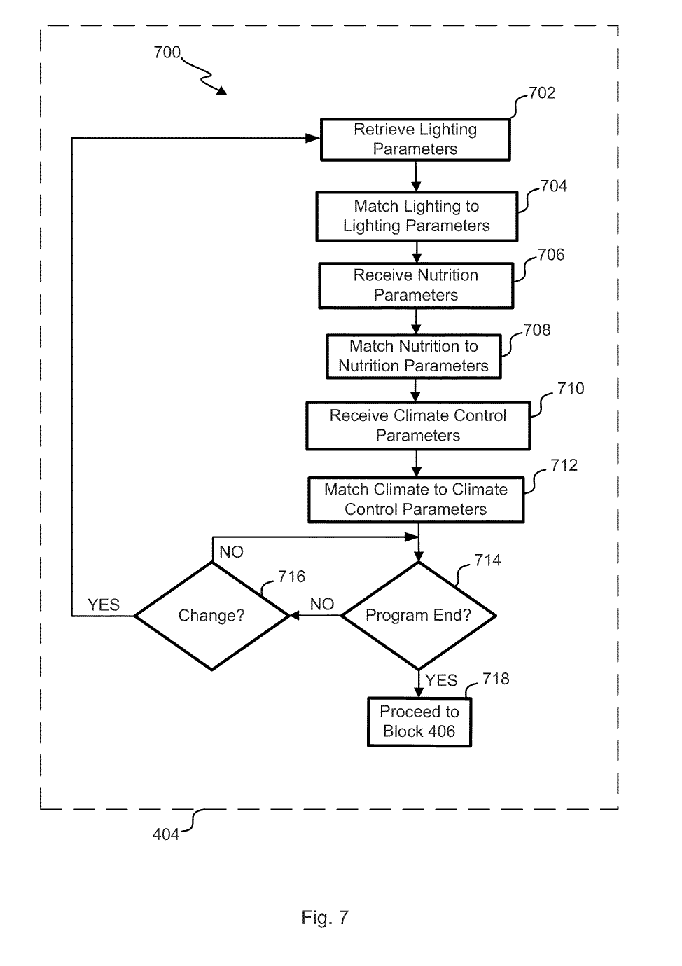

With reference now to FIG. 7, a flowchart illustrating one embodiment of a process 700 for implementing an operation program is shown. The process 700 can be performed in the place of, or as a part of the step shown in block 404 of FIG. 4.

The process begins at block 702, wherein lighting parameters are retrieved from the database server 210, and specifically from the program database 302 of the database server 210. In some embodiments, the lighting parameters can specify, for example, the duration of a “day” and a “night” period, a frequency and/or frequency composition for illumination of the plant, an illumination intensity, a position of the illumination system 108, or the like.

After the lighting parameters have been retrieved, the process 700 proceeds to block 704, wherein the lighting is matched to the lighting parameters. In some embodiments, this can include the generation of one or several control signals by the processor 112 to control the amount and frequency and/or frequency composition of light generated by the light sources 110, as well as to control the positioning of the illumination system 108 via the light positioning system 142. In some embodiments, this can further include the triggering of a clock with the sending of the control signals to determine, if desired, when to transition between growth periods such as, for example, between “day” and “night.” These control signals are received by the illumination system 108 and/or by the light positioning system 142, and the plant 130 is illuminated as prescribed by the operation program.

After the lighting is matched to the lighting parameters, the process 700 proceeds to block 706, wherein nutrition parameters are received. In some embodiments, the nutrition parameters specify nutrition levels identified in the operation program, including, for example, desired soil moisture/hydration levels, growth media nutrition levels, concentration of nutrients in the water, and/or the like. In some embodiments, these nutrition parameters can be specific as to the degree to which one or several elements and/or chemicals are provided to the plant, and in some embodiments, these parameters can specify acceptable ranges of degrees to which one or several elements and/or chemical are provided to the plant. These nutrition parameters can be retrieved from the database server 210, and in some embodiments, can be retrieved from the program database 302 in the database server.

After the nutrition parameters have been retrieved, the process 700 proceeds to block 708, wherein the nutrition levels provided to the plant are matched to the nutrition parameters. In some embodiments, this can include determining whether the current nutrition levels are greater than, less than, or equal to the nutrition parameters, and taking remedial action based on this determination. In some embodiments, for example, wherein a nutrition level is higher than the nutrition parameter, then additional water can be added to the reservoir 106 to dilute nutrition concentrations in the water and thereby decrease the nutrition provided to the plant 130. Similarly, if it is determined that nutrition levels are too low, then additional elements, chemicals, and/or fertilizers can be added to the water in the reservoir 106 and/or to the growth media by, for example, the nutrition system 144.

After the nutrition levels have been matched to the nutrition parameters, the process 700 proceeds to block 710, wherein one or several climate control parameters are retrieved from the database server 210, and specifically from the program database 302 of the database server 210. In some embodiments, these parameters can specify one or several climate parameters for the enclosed area 202 such as, for example, a temperature, a humidity such as a relative humidity, an atmospheric pressure, air composition levels such as, for example, the amount of carbon dioxide in the air, or the like.

After the climate control parameters have been retrieved, the process 700 proceeds to block 712, wherein the climate in the enclosed area 202 is matched to the climate control parameters. In some embodiments, this can include receiving climate data from the climate sensors 148 and determining whether current conditions in the enclosed area 202 are greater than, less than, or equal to the conditions identified in the climate parameters. If it is determined that the current conditions are greater than or less than the conditions specified in the climate parameters, then one or several control signals can be generated by the processor 112 and sent to the climate control system 204, which signals can direct the climate control system 204 to operate so as to eliminate and/or decrease this discrepancy.

After the climate has been matched to the climate parameters, the process 700 proceeds to decision state 714, wherein it is determined if the operation program should end and/or has been completed. In some embodiments, this determination can include prompting a user via, for example, the user device 206 for an input identifying whether the operation program has been completed.

In one embodiment, this determination of whether to end the operation program can include receiving sensor data from the plant sensor 150, which data can indicate a plant size, a plant weight, a plant composition, such as, for example, the chemical and/or pharmacological composition of the plant, the plant age, the plant maturity and/or the maturity of the harvest, or the like. Based on this data, the processor 112 can determine whether the desired outcome of the running of the operation program has been achieved, and if the outcome has been achieved, then the program can be terminated.

Alternatively, in one embodiment, this determination of whether to end the operation program can include receiving and/or retrieving data identifying the duration of the operation program at completion, and the current duration of the operation program. The current duration of the operation program can be compared with the duration of the operation program at completion, and the program can be terminated if the current duration of the operation program is greater than or equal to the duration of the operation program at completion.

If it is determined that the operation program should end, then the process 700 proceeds to block 718 and continues with block 406 of FIG. 4. If it is determined that the operation program should not end, the process 70 proceeds to decision state 716, wherein it is determined if the operation program indicates a change to one or several of the environmental parameters. In some embodiments, these changes to the environmental parameter may be the result of some aspect of the plant 130 such as, for example, the size of the plant 130, the age of the plant 130, the maturity of the plant 130 and/or harvest of the plant 130, the composition of the plant 130, a rate of growth of the plant 130, a nutrient level and/or chemical level, including a pharmacological level in the plant 130, or the like.

If it is determined that the operation program is not specifying a change to one or several of the environmental parameters, then the process 700 returns to decision state 714, and proceeds as outlined above. In some embodiments, and before the process 700 returns to decision state 714, the process 700 can wait a period of time, which period can be predetermined. In some embodiments, this period of time can be, 1 minute, 5 minutes, 10 minutes, 20 minutes, 30 minutes, 1 hour, 2 hours, 6 hours, 12 hours, 1 day, 1 week, 1 month, and/or any other or intermediate time. Returning again to decision state 716, if the operation program specifies changes to one or several of the environmental parameters, then the process 700 returns to block 702, and proceeds as outlined above. In some embodiments, and before the process 700 returns to block 702, the process 700 can wait a period of time, which period can be predetermined. In some embodiments, this period of time can be, 1 minute, 5 minutes, 10 minutes, 20 minutes, 30 minutes, 1 hour, 2 hours, 6 hours, 12 hours, 1 day, 1 week, 1 month, and/or any other or intermediate time.

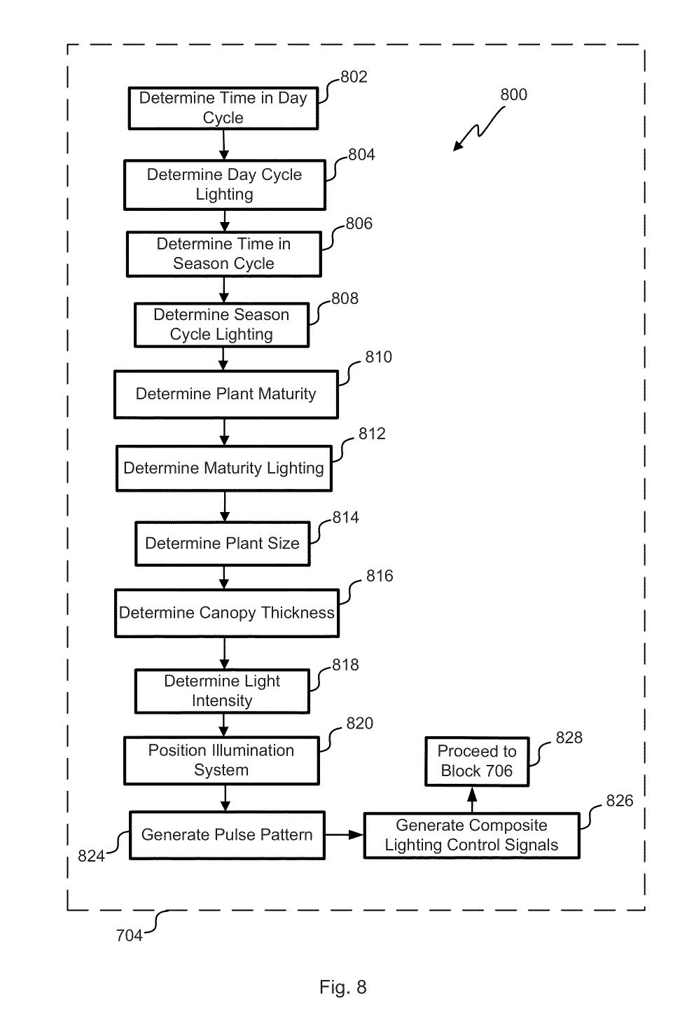

With reference now to FIG. 8, a flowchart illustrating one embodiment of a process 800 for matching lighting to lighting parameters specified in the operation program is shown. In some embodiments, the process 800 can be performed in the place of, or as a part of block 704 of FIG. 7. The process 800 begins at block 802, wherein the time in the day cycle is determined.

In some embodiments, the day cycle can be a lighting pattern that mimics lighting occurring during a revolution of the earth, although a day cycle may be longer or shorter than 24 hours, and the “day” and “night” portion of the day cycle may be longer or shorter than any actual day or night. In some embodiments, the determination of the time in the day cycle can be accomplished by retrieving data from one or several clocks that track the day cycle and by retrieving data from the database server 210, and specifically from the program database 302 of the database server, which data specifies the duration of the day cycle and the duration of the “day” and “night” in the day cycle. The clock data can be compared with the data retrieved from the database server 210 to determine the time and/or progression through the day cycle.

After the time in the day cycle has been determined, the process 800 proceeds to block 804, wherein day cycle lighting is determined. In some embodiments, for example, at least one of the intensity, the angle of incidence, and the frequency composition of illumination can vary during the day cycle. In one particular embodiment, for example, sunrise and sunset may include a first frequency composition, illumination intensity, and/or angle of incidence of light on the plant, and midday may have a second frequency composition, illumination intensity, and/or angle of incidence of light on the plant. These differences in illumination between times in the day cycle can affect a plants growth and the mimicking of these conditions can, as part of the operation program, be used to achieve a desired outcome. With the determination of the time in the day cycle from block 802, the day cycle lighting can be determined by retrieving day cycle lighting data corresponding to the time in the day cycle from the database server 210, and particularly from the program database 302 of the database server 210.

After the day cycle lighting has been determined, the process 800 proceeds to block 806, wherein the time in the season cycle is determined. In some embodiments, this determination can be similar to the determination of time in the day cycle. Specifically, in some embodiments, data identifying the progression of the operation program can be received from one or several clocks, and data identifying seasonal lighting during the running of the operation program can be retrieved from, for example, the database server 210, and specifically form the program database 302. The data from the clocks can be compared to the data retrieved from the database server 210 to determine the progression through the season cycle in the operation program.

After the progression through the season cycle has been determined, the process 800 proceeds to block 808, wherein the season cycle lighting is determined. In some embodiments, for example, at least one of the intensity, the angle of incidence, and the frequency composition of illumination can vary during the season cycle. In one particular embodiment, for example, spring and/or fall, or a time within spring and/or fall, may include a first frequency composition, illumination intensity, and/or angle of incidence of light on the plant, and summer, or a time within summer, may have a second frequency composition, illumination intensity, and/or angle of incidence of light on the plant. These differences in illumination between seasons can affect a plants growth and the mimicking of these conditions can, as part of the operation program, be used to achieve a desired outcome. With the determination of the time in the season cycle from block 806, the season cycle lighting can be determined by retrieving season cycle lighting data corresponding to the time in the season cycle from the database server 210, and particularly from the program database 302 of the database server 210.

After the season cycle lighting has been determined, the process 800 proceeds to block 810, wherein the plant maturity is determined. In some embodiments, the plant maturity can be determined by comparing information from the plant database 304 to data from one or several clocks tracking the progress of the operation program. Alternatively, in some embodiments, the maturity of the plant can be determined based on a user input indicating the maturity of the plant, and/or via one or several attribute of the plant, as determined by the plant sensor 150. In some embodiments, these one or several indicators can include any indicator of plant age and/or maturity including, for example, the plant size, weight, color, composition, or the like. Information relating to the plant's maturity can be stored in the database server 210, and specifically in the plant database 304 of the database server 210.

After the plant maturity has been determined, the process 800 proceeds to block 812, wherein the maturity lighting is determined. As mentioned above some plants have different reactions to different lighting, and specifically to illumination of different intensities, or different frequency composition, and/or of different angles of incidence. In some embodiments, these different reaction and/or affects can be advantageously used to achieve one or several desired outcomes. Advantageously, by determining the maturity of the plant in block 812, the lighting corresponding to a desired affect can be determined for the plant based on the maturity of the plant.

After the maturity lighting has been determined, the process 800 proceeds to block 814, wherein the plant size is determined. In some embodiments, this determination of the plant size can include determining the height of the plant, the volume filled by the plant, or the like. The size of the plant can be determined based on a user input received in response to a prompt, and/or can be determined by the plant sensor 150. In some embodiments, the plant sensor 150 can include one or several cameras that can generate images that can be used to determine, for example, the height of the plant 130 and/or the volume filed by the plant. This information can be, for example, stored in the database server 210, and specifically in the plant database 304 of the database server 210.

After the plant size has been determined, the process 800 proceeds to block 816, wherein the canopy thickness of the plant 130 is determined. In some embodiments, this determination can be made to identify the degree to which interior portions of the canopy are filled by the plant and to identify the degree to which these interior portions of the canopy are illuminated. In some embodiments, the determination of the canopy thickness can be based on a user input received in response to a prompt, and/or can be determined by the plant sensor 150. In such an embodiment, the plant sensor can comprise one or several cameras that can be used to generate image data that can be used to determine the canopy thickness of the plant 130.

After the canopy thickness has been determined, an illumination intensity can be determined. In some embodiments, the illumination intensity can be determined based on one or all of the day cycle lighting, the season cycle lighting, the maturity lighting, and the canopy thickness. In some embodiments, this intensity of the illumination can be selected to increase illumination in the inner portions of the canopy of the plant. In one embodiment the illumination can be selected to impart the maximum benefit to the plant while using the least amount of energy to achieve that benefit.

After the illumination intensity has been determined, the process 800 proceeds to block 820, wherein the illumination system 108 is positioned. In some embodiments, this can include determining a desired positioning of the illumination system 108 with respect to the plant 130, including, for example, a distance from the plant 130 and/or an angle with respect to the plant 130. In some embodiments, the illumination system 108 can be positioned so that the light better penetrates the canopy of the plant, which can include positioning the illumination system 108 relatively closer to, relatively farther from, and/or at an angle relative to the plant 130. In some embodiments, the illumination system 108 can be positioned as close as possible to the plant 130 without contacting any portion of the plant.

After the desired positioning of the illumination system 108 is determined, the processor 112 can generate one or several control signals to direct the light positioning system 142 to position the illumination system 108 at the desired position. These control signals can be provided to the light positioning system 142 and the light positioning system 142 can move the illumination system 108 to the desired location.

After the illumination system 108 is positioned, the process 800 proceeds to block 824, wherein a pulse pattern is generated. In some embodiments, a pulse pattern can describe a way in which one or several of the light sources are controlled to generate pulse of light of different intensities. In some embodiments, the pulse pattern may prescribe the generation of light at 2, 3, 4, 5, 6, 8, 10, and/or any other number of different intensities. In some embodiments, the pulse pattern may prescribe the switching between generating light and not generating light.

In some embodiments, the pulse pattern can be used to allow illumination of the plant at intensities that are sufficiently high to damage the plant if the illumination is constant. By pulsing the illumination, these high intensities can be used without damaging the plant. The details of how the illumination pattern is determined are discussed at greater length below.

After the pulse pattern has been generated, the process 800 proceeds to block 826, wherein one or several composite lighting control signals are generated. In some embodiments, these composite lighting control signals can be based on the different types of lighting determined in block 802 to 824, and the composite lighting control signals can be generated by the processor 112. After the composite lighting control signals have been generated, the process 800 proceeds to block 828, and continues with block 706 in FIG. 7.

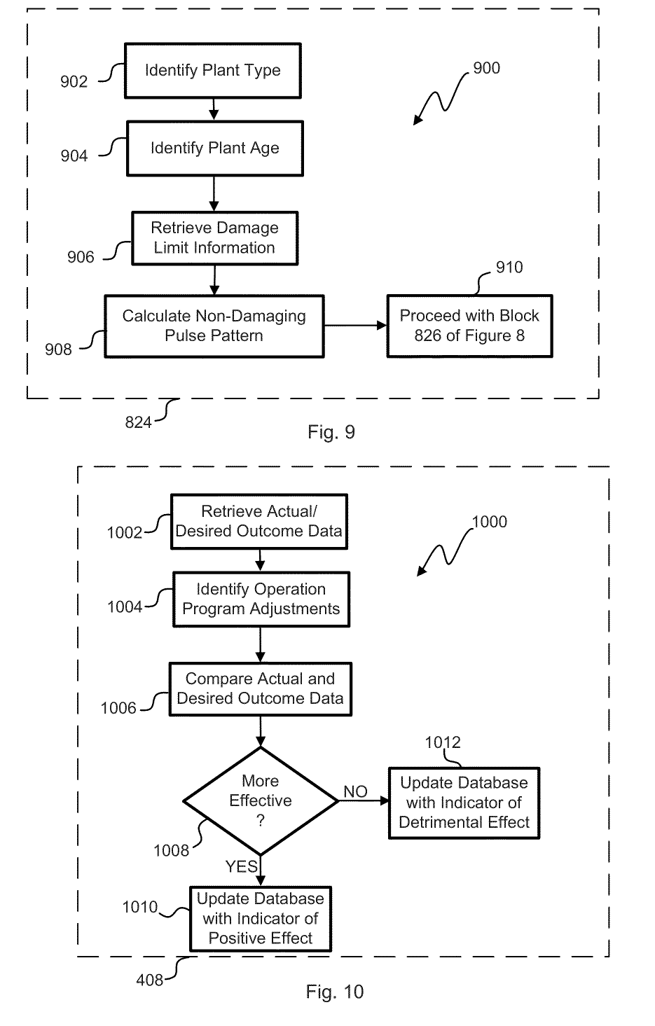

With reference now to FIG. 9, a flowchart illustrating one embodiment of a process 900 for generating a pulse pattern is shown. The process 900 can be performed as part of, or in the place of block 824 of FIG. 8. The process begins at block 902, wherein the plant type is identified. In some embodiments, this can be performed by the retrieving of information identifying the plant from the database server 210, and specifically from the plant database 304 of the database server 210. After the plant type has been identified, the process 900 proceeds to block 904, wherein the plant age and/or maturity level is identified. In some embodiments this can be determined by retrieving the plant maturity information from the database server 210, and specifically from the plant database 304 of the database server 210.

After the plant maturity has been determined, the process 900 proceeds to block 906 wherein damage limit information is retrieved. In some embodiments, the damage limit information can define the maximum amount of light that can impinge on all or portions of the plant before those portions of the plant are damaged. In some embodiments, the damage limit can specify a maximum amount of photons per unit time that can be absorbed by a plant without being damaged. This unit of time can be, for example, per fraction of a second, per second, per minute, per day, per growth period, per day cycle, per season, or the like. In some embodiments, this limit can vary based on a variety of parameters such as, for example, the maturity of the plant, the type of plant, or the like. In some embodiment, the damage limit information can be retrieved from the database server 210 using the information retrieved in blocks 902 and 904, and specifically can be retrieved from the plant database 304 of the database server 210.

After the plant damage limit information has been retrieved, the process 900 proceeds to block 908, wherein the non-damaging pulse pattern is calculated. In some embodiments, the non-damaging pulse pattern can be the pulse pattern than can deliver the maximum amount of energy via illumination to the plant per unit time without damaging the plant. In some embodiments, the duration of the pulses of illumination can be calculated as the length of time, and/or the total length of time, that delivers energy up to the damage limit, and the duration of time in which there is no illumination can be shortest amount of time required for the plant to have recovered so as to be able to receive another non-damaging pulse of light. Alternatively, in some embodiments, the duration of the pulses of illumination can be calculated by determining the damage limit, the desired intensity of the light, and the duration of the day cycle. With this information, the duration of the time can be determined in which the light sources operating at the desired power level to generate light of the desired intensity will reach the damage limit. A frequency can then be selected, for which the sum of the duration of the time in which the light sources are generating light is equal to the duration of time in which the light sources operating at the desired power level generate sufficient light to reach the damage limit. The non-damaging pulse pattern can be calculated by the processor 112, and can be stored in the database server 210, and particularly in the program database 302 of the database server 210. After the non-damaging pulse pattern has been generated, the process 900 proceeds to block 910 and continues with block 826 of FIG. 8

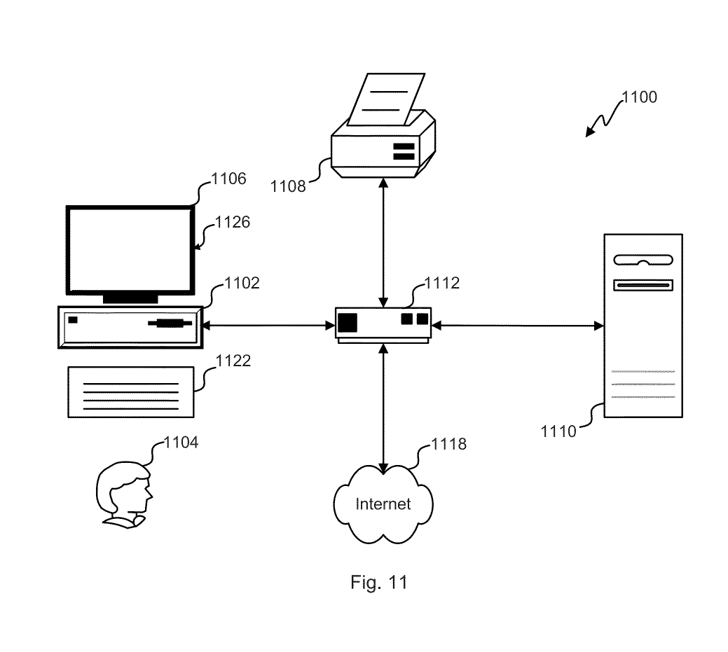

With reference now to FIG. 10, a flowchart illustrating one embodiment of a process 1000 for evaluating the result of an operation program is shown. The process 1000 can be performed as part of, or in the place of block 408 of FIG. 4. The process 1000 begins at block 1002 wherein the actual and desired outcome data is retrieved. In some embodiments, the actual and desired outcome data can be retrieved from the database server 210, and particularly from the results database 306 of the database server 210. After the actual and desired outcome data has been retrieved, the process 1000 proceeds to block 1004, wherein any changes to the operation program are identified. In some embodiments, information identifying these changes can be stored in the database server 210, and particularly in the program database 302 of the database server 210.

After the operation program adjustments have been identified, the process 1000 proceeds to block 1006 wherein the actual and the desired outcome data are compared. In some embodiments, this comparison can determine whether the actual result achieved was better, worse, and/or equal to the desired result. In some embodiments, a value indicative of the comparison can be associated with one or both of the actual result and the optimized operation program. In some embodiments, for example, this value can be a first value if the result was better than desired, a second value if the result is equal to the desired result, and a third value if the result is worse than the desired result.

After the comparison of the actual and desired results, the process 1000 proceeds to decision state 10008, wherein it is determined if the optimized operation program was more effective. In some embodiments, this can include the retrieval of the values associated with the optimized operation program and/or the actual result. If the first value is retrieved, then the process 1000 proceeds to block 1010, wherein the database server 210 is updated with the first value, and specifically wherein the first value is associated with the optimized operation program in the program database 302, the plant database 304, and/or the results database 306. In some embodiments, this update can be specific to the operation program, and specifically with the optimized operation program, and in some embodiments, this update can be associated with the optimizations to the operating program. Returning again to decision state 1008, if the third value is retrieved, then the process 1000 proceeds to block 1012, wherein the database server 210 is updated with the third value, and specifically wherein the third value is associated with the optimized operation program in the program database 302, the plant database 304, and/or the results database 306. In some embodiments, this update can be specific to the operation program, and specifically with the optimized operation program, and in some embodiments, this update can be associated with the optimizations to the operating program. Similarly, updates can be performed in the event that the second value is identified.

With reference now to FIG. 11, an exemplary environment with which embodiments may be implemented is shown with a computer system 1100 that can be used by a user 1104 as all or a component of the grow system 200. The computer system 1100 can include a computer 1102, keyboard 1122, a network router 1112, a printer 1108, and a monitor 1106. The monitor 1106, processor 1102 and keyboard 1122 are part of a computer system 1126, which can be a laptop computer, desktop computer, handheld computer, mainframe computer, etc. The monitor 1106 can be a CRT, flat screen, etc.

A user 1104 can input commands into the computer 1102 using various input devices, such as a mouse, keyboard 1122, track ball, touch screen, etc. If the computer system 1100 comprises a mainframe, a designer 1104 can access the computer 1102 using, for example, a terminal or terminal interface. Additionally, the computer system 1126 may be connected to a printer 1108 and a server 1110 using a network router 1112, which may connect to the Internet 1118 or a WAN.

The server 1110 may, for example, be used to store additional software programs and data. In one embodiment, software implementing the systems and methods described herein can be stored on a storage medium in the server 1110. Thus, the software can be run from the storage medium in the server 1110. In another embodiment, software implementing the systems and methods described herein can be stored on a storage medium in the computer 1102. Thus, the software can be run from the storage medium in the computer system 1126. Therefore, in this embodiment, the software can be used whether or not computer 1102 is connected to network router 1112. Printer 1108 may be connected directly to computer 1102, in which case, the computer system 1126 can print whether or not it is connected to network router 1112.

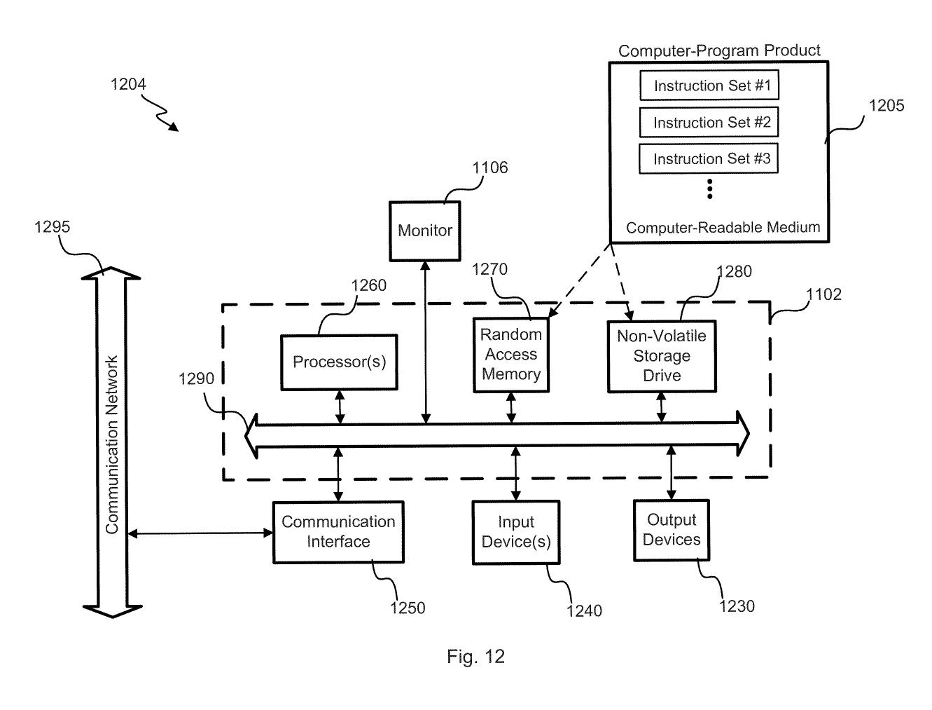

With reference to FIG. 12, an embodiment of a special-purpose computer system 1204 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1126, it is transformed into the special-purpose computer system 1204.

Special-purpose computer system 1204 comprises a computer 1102, a monitor 1106 coupled to computer 1102, one or more additional user output devices 1230 (optional) coupled to computer 1102, one or more user input devices 1280 (e.g., keyboard, mouse, track ball, touch screen) coupled to computer 1102, an optional communications interface 1250 coupled to computer 1102, a computer-program product 1205 stored in a tangible computer-readable memory in computer 1102. Computer-program product 1205 directs system 1204 to perform the above-described methods. Computer 1102 may include one or more processors 1260 that communicate with a number of peripheral devices via a bus subsystem 1290. These peripheral devices may include user output device(s) 1230, user input device(s) 1240, communications interface 1250, and a storage subsystem, such as random access memory (RAM) 1270 and non-volatile storage drive 1280 (e.g., disk drive, optical drive, solid state drive), which are forms of tangible computer-readable memory.

Computer-program product 1205 may be stored in non-volatile storage drive 1280 or another computer-readable medium accessible to computer 1102 and loaded into memory 1270. Each processor 1260 may comprise a microprocessor, such as a microprocessor from Intel® or Advanced Micro Devices, Inc.®, or the like. To support computer-program product 1205, the computer 1102 runs an operating system that handles the communications of product 1205 with the above-noted components, as well as the communications between the above-noted components in support of the computer-program product 1205. Exemplary operating systems include Windows® or the like from Microsoft® Corporation, Solaris® from Oracle®, LINUX, UNIX, and the like.

User input devices 1240 include all possible types of devices and mechanisms to input information to computer system 1102. These may include a keyboard, a keypad, a mouse, a scanner, a digital drawing pad, a touch screen incorporated into the display, audio input devices such as voice recognition systems, microphones, and other types of input devices. In various embodiments, user input devices 1240 are typically embodied as a computer mouse, a trackball, a track pad, a joystick, wireless remote, a drawing tablet, a voice command system. User input devices 1240 typically allow a user to select objects, icons, text and the like that appear on the monitor 1106 via a command such as a click of a button or the like. User output devices 1230 include all possible types of devices and mechanisms to output information from computer 1102. These may include a display (e.g., monitor 1106), printers, non-visual displays such as audio output devices, etc.

Communications interface 1250 provides an interface to other communication networks 1295 and devices and may serve as an interface to receive data from and transmit data to other systems, WANs and/or the Internet 1118. Embodiments of communications interface 1250 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1250 may be coupled to a computer network, to a FireWire® bus, or the like. In other embodiments, communications interface 1250 may be physically integrated on the motherboard of computer 1102, and/or may be a software program, or the like.

RAM 1270 and non-volatile storage drive 1280 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1270 and non-volatile storage drive 1280 may be configured to store the basic programming and data constructs that provide the functionality of various embodiments of the present invention, as described above.

Software instruction sets that provide the functionality of the present invention may be stored in RAM 1270 and non-volatile storage drive 1280. These instruction sets or code may be executed by the processor(s) 1260. RAM 1270 and non-volatile storage drive 1280 may also provide a repository to store data and data structures used in accordance with the present invention. RAM 1270 and non-volatile storage drive 1280 may include a number of memories including a main random access memory (RAM) to store of instructions and data during program execution and a read-only memory (ROM) in which fixed instructions are stored. RAM 1270 and non-volatile storage drive 1280 may include a file storage subsystem providing persistent (non-volatile) storage of program and/or data files. RAM 1270 and non-volatile storage drive 1280 may also include removable storage systems, such as removable flash memory.

Bus subsystem 1290 provides a mechanism to allow the various components and subsystems of computer 1102 communicate with each other as intended. Although bus subsystem 1290 is shown schematically as a single bus, alternative embodiments of the bus subsystem may utilize multiple busses or communication paths within the computer 1102.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. An active growth controller system comprising:
an active growth control device comprising:
an illumination system configured to illuminate a growth region, wherein one or several plants can be located in the growth region;
a memory containing stored instructions, wherein the stored instructions comprise a plurality of operating programs, wherein the operating programs contains parameters for controlling at least one of the climate control system and the illumination system;
a processor configured to:
receive first plant data, wherein the first plant data identifies at least one of: a plant type; a plant age; a plant size, and a desired harvest outcome at a first time;
retrieve the operating programs;
identify an operating program corresponding to the first plant data;
generate and send first control signals to the illumination system to control illumination of the growth region, wherein the first control signals are generated based on the operating program and the first plant data;
receive second plant data, wherein the second plant data identifies at least one of a plant age, a plant size, and progress towards a desired harvest outcome at a second time; and
generate and send second control signals to the illumination system to control illumination of the growth region, wherein the second control signals are generated based on the operating program and the second plant data.

2. The system of claim 1, wherein the active growth control controller system comprises an irrigation system configured to provide water to the growth region according to one or several irrigation control signals.

3. The system of claim 2, wherein the active growth control device is located in an enclosed agricultural hall, and wherein the active growth controller system comprises:
a climate control system, wherein the climate control system is configured to affect at least one of a temperature and a relative humidity within the enclosed agricultural hall.

4. The system of claim 3, wherein the processor is further configured to receive first climate data from the climate control system and to generate and send third control signals to the climate control system, wherein the third control signals are generated based on the first plant data and the operating program, and wherein the third control signals direct operation of the climate control system to achieve at least one of a first desired temperature and a first desired relative humidity within the enclosed agricultural hall.

5. The system of claim 4, wherein the processor is further configured to receive second climate data from the climate control system and to generate and send fourth control signals to the climate control system, wherein the fourth control signals are generated based on the second plant data and the operating program, and wherein the fourth control signals direct operation of the climate control system to achieve at least one of a second desired temperature and a second desired relative humidity within the enclosed agricultural hall.

6. The system of claim 5, wherein the at least one of the first desired temperature and the first desired relative humidity are different than the second desired temperature and the second desired relative humidity and wherein the first plant data is different than the second plant data.

7. The system of claim 1, wherein the first control signals specify at least one of a first illumination intensity and a first frequency composition of light generated by the illumination system, wherein the second control signals specify at least one of a second illumination intensity and a second frequency composition of light generated by the illumination system, and wherein the at least one of the first illumination intensity and the first frequency composition is matched to at least one of the plant age and the plant size at the first time and the at least one of the first illumination intensity and the first frequency composition is matched to at least one of the plant age and the plant size at the second time.

8. The system of claim 7, wherein the processor is configured to adjust at least one of the first and second control signals to simulate at least one of the illumination intensity and the frequency composition of at least one of a sunrise and a sunset, and a season.

9. The system of claim 8, wherein the processor is configured to adjust the frequency composition by varying at least one of the red and blue frequency components of the light generated by the illumination system.

10. The system of claim 9, wherein the frequency composition of the light generated by the illumination system is adjusted without diminishing the power output of the illumination system.

11. The system of claim 10, wherein the illumination system comprises a red light source, a blue light source, and a broad-spectrum light source.

12. The system of claim 11, wherein the frequency composition is adjusted by decreasing the power provided to one of the red light source and the blue light source and by increasing the power provided to the other of the red light source and the blue light source.

13. The system of claim 12, wherein the frequency composition is adjusted by increasing the power provided to the broad-spectrum light source.

14. A method of optimizing plant growth, the method comprising:
receiving first plant data, wherein the first plant data identifies at least one of: a plant type; a plant age; a plant size, and a desired harvest outcome at a first time;
receiving grow parameter data, wherein the grow parameter data specifies at least one of an available grow time, data specifying available energy or irrigation resources and a cost parameter, wherein the cost parameter identifies a maximum cost for completion of the grow;
identifying an operating program corresponding to the first plant data and the grow parameter data, wherein the operating program comprises a control parameter for controlling the operation of an active growth control system comprising: a memory, a processor, and an illumination system configured to illuminate one or several plants in a growth region;
generating and outputting first control signals to the illumination system, wherein the first control signals are configured to control illumination of the growth region, wherein the first control signals are generated based on the operating program and the first plant data;
receiving second plant data, wherein the second plant data identifies at least one of a plant age, a plant size, plant weight, and progress towards a desired harvest outcome at a second time; and
generating and sending second control signals to the illumination system to control illumination of the growth region, wherein the second control signals are generated based on the operating program and the second plant data.

15. The method of claim 14, further comprising receiving first climate data from the climate control system and generating and sending third control signals to the climate control system, wherein the third control signals are generated based on the first plant data and the operating program, and wherein the third control signals direct operation of the climate control system to achieve at least one of a first desired temperature and a first desired relative humidity within the enclosed agricultural hall.

16. The method of claim 15, further comprising receiving second climate data from the climate control system and generating and sending fourth control signals to the climate control system, wherein the fourth control signals are generated based on the second plant data and the operating program, and wherein the second control signals direct operation of the climate control system to achieve at least one of a second desired temperature and a second desired relative humidity within the enclosed agricultural hall.

17. The method of claim 16, wherein the first control signals specify at least one of a first illumination intensity and a first frequency composition of light generated by the illumination system, wherein the fourth control signals specify at least one of a second illumination intensity and a second frequency composition of light generated by the illumination system, and wherein the at least one of the first illumination intensity and the first frequency composition is matched to at least one of the plant age and the plant size at the first time and the at least one of the second illumination intensity and the second frequency composition is matched to at least one of the plant age and the plant size at the second time.

18. The method of claim 17, further comprising adjusting the frequency composition of light generated by the illumination system by:
determining a first power output level of the illumination system at a first instance;
generating a first signal to direct the decrease of illumination generated by one of a red light source and a blue light source; and
generating a second signal to direct the increase of illumination generated by the other of the red light source and the blue light source such that the power output level of the illumination system after the first and second signals is the same as at the first instance.

19. The method of claim 18, further comprising:
determining the completion of the operating program;
determining a parameter of the result of the operating program, wherein the parameter characterizes a yield from the operating program;
comparing the parameter of the result of the operating program to parameters of results received from other programs; and
identifying the relative effectiveness of the completed operating program.

20. The method of claim 19, wherein the parameter of the result of the operating program comprises one of:
a descriptor of harvest size;
a descriptor of a consumer satisfaction level;
a descriptor of a chemical composition;
a descriptor of a presence of a pharmacological property; and
a descriptor of a visual attribute.
